(19) United States
(12) Patent Application Publication
(10) Pub. No.: US 2026/0100802 A1
(43) Pub. Date: Apr. 9, 2026

(54) TECHNIQUES FOR SOUNDING REFERENCE SIGNAL CARRIER SWITCHING AND UPLINK TRANSMISSION SWITCHING

(71) Applicant: QUALCOMM Incorporated, San Diego, CA (US)

(72) Inventors: Alberto RICO ALVARINO, San Diego, CA (US); Enoch Shiao-Kuang LU, San Diego, CA (US); Pranay Sudeep RUNGTA, New York, NY (US)

(21) Appl. No.: 19/348,439

(22) Filed: Oct. 2, 2025

Related U.S. Application Data
(60) Provisional application No. 63/703,839, filed on Oct. 4, 2024.

(51) Int. Cl. H04L 5/00

(52) U.S. Cl. CPC H04L 5/0078; H04L 5/0048

(57) ABSTRACT

Various aspects of the present disclosure generally relate to wireless communication. In some aspects, a user equipment (UE) may transmit capability information indicating a first capability switching time associated with switching a first number of transmit chains from a first uplink transmission component carrier to a sounding reference signal (SRS) component carrier and a second capability switching time associated with switching a transmit chain from a second uplink transmission component carrier to the first uplink transmission component carrier. The UE may perform a transmission based on a determination of an SRS switching time associated with an SRS transmission. Numerous other aspects are described.

### CROSS-REFERENCE TO RELATED APPLICATION

This Patent Application claims priority to U.S. Provisional Patent Application No. 63/703,839, filed on October 4, 2024, entitled “TECHNIQUES FOR SOUNDING REFERENCE SIGNAL CARRIER SWITCHING AND UPLINK TRANSMISSION SWITCHING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with sounding reference signal carrier switching and uplink transmission switching.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include transmitting capability information, wherein the capability information indicates a first capability switching time associated with switching a first number of transmit chains from a first uplink transmission component carrier to a sounding reference signal (SRS) component carrier associated with transmitting an SRS and a second capability switching time associated with switching a transmit chain from a second uplink transmission component carrier to the first uplink transmission component carrier. The method may include receiving an indication to transmit an SRS in the SRS component carrier. The method may include performing a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

Some aspects described herein relate to a method of wireless communication performed by a network node. The method may include transmitting, to a UE, a request for capability information. The method may include receiving the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, where a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

Some aspects described herein relate to a non-transitory computer-readable medium that stores a set of instructions for wireless communication by a UE. The set of instructions, when executed by one or more processors of the UE, may cause the UE to transmit capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier. The set of instructions, when executed by one or more processors of the UE, may cause the UE to receive an indication to transmit an SRS in the SRS component carrier. The set of instructions, when executed by one or more processors of the UE, may cause the UE to perform a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

Some aspects described herein relate to a non-transitory computer-readable medium that stores a set of instructions for wireless communication by a network node. The set of instructions, when executed by one or more processors of the network node, may cause the network node to transmit, to a UE, a request for capability information. The set of instructions, when executed by one or more processors of the network node, may cause the network node to receive the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, where a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

Some aspects described herein relate to a UE for wireless communication. The UE may include one or more memories and one or more processors coupled to the one or more memories. The one or more processors may be configured to transmit capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier. The one or more processors may be configured to receive an indication to transmit an SRS in the SRS component carrier. The one or more processors may be configured to perform a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

Some aspects described herein relate to a network node for wireless communication. The network node may include one or more memories and one or more processors coupled to the one or more memories. The one or more processors may be configured to transmit, to a UE, a request for capability information. The one or more processors may be configured to receive the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, where a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

Some aspects described herein relate to an apparatus for wireless communication. The apparatus may include means for transmitting capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier. The apparatus may include means for receiving an indication to transmit an SRS in the SRS component carrier. The apparatus may include means for performing a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

Some aspects described herein relate to an apparatus for wireless communication. The apparatus may include means for transmitting, to a UE, a request for capability information. The apparatus may include means for receiving the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, where a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3-8 are diagrams illustrating examples associated with sounding reference signal carrier switching and uplink transmission switching, in accordance with the present disclosure.

FIG. 9 is a diagram illustrating an example process performed, for example, at a user equipment (UE) or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some cases, a user equipment (UE) may be configured with a total number (e.g., 1, 2, 4, or the like) of transmit chains, antennas, and/or ports. In some cases, the UE may be configured to utilize a number (e.g., 1 or 2) of transmit chains, antennas, and/or ports to transmit a sounding reference signal (SRS) via the SRS component carrier (e.g., a component carrier associated with transmitting an SRS). For example, the UE may transmit capability information to a network node indicating the total number of transmit chains, antennas, and/or ports. The network node may transmit configuration information indicating the number of transmit chains, antennas, and/or ports that the UE is to utilize to transmit an SRS based at least in part on the capability information.

In some cases, prior to receiving an indication to transmit an SRS, the transmit chains, antennas, and/or ports of the UE may be associated with one or more component carriers other than the SRS component carrier. In these cases, upon receiving an indication from a network node to transmit an SRS, the UE may cause one or more transmit chains, antennas, and/or ports to be switched to the SRS component carrier based at least in part on the number of transmit chains, antennas, and/or ports indicated in the configuration information.

In some cases, the capability information may indicate an SRS carrier switching capability (which can be called a second capability switching time in the context) and/or an uplink transmission switching time (which can be called a first capability switching time in the context). The SRS carrier switching capability may indicate an amount of time associated with the UE retuning an antenna and/or switching a transmit chain from a first component carrier (corresponding to a second uplink transmission component carrier in the context) to a component carrier via which an SRS is to be transmitted (e.g., an SRS component carrier). The uplink transmission switching time may indicate an amount of time associated with the UE retuning an antenna and/or switching a transmit chain from a second component carrier (corresponding to a first uplink transmission component carrier in the context) (e.g., a component carrier that is different from the first component carrier and the SRS component carrier) to the first component carrier.

For example, the UE may be configured with a total of two transmit chains, antennas, and/or ports and may be configured to utilize two transmit chains, antennas, and/or ports to transmit an SRS via the SRS component carrier. At a time that the indication is received by the UE, the two transmit chains, antennas, and/or ports may be associated with one or more uplink transmission component carriers.

For example, one transmit chain, antenna, and/or port may be associated with the first uplink transmission component carrier and the other transmit chain, antenna, and/or port may be associated with the second uplink transmission component carrier. For this example, the time required for the UE to switch the two transmit chains, antennas, and/or ports to the SRS component carrier depends on whether the transmit chain, antenna, and/or port associated with the first uplink transmission component carrier is to be switched to the second uplink transmission component carrier and then to the SRS component carrier or from the first uplink transmission component carrier directly to the SRS component carrier.

Because the network node may be unaware of how the transmit chains, antennas, and/or ports are to be switched to the SRS component carrier, the network node may be unable to accurately determine an amount of time required for the UE to switch the transmit chains, antennas, and/or ports to the SRS component carrier. Further, because the capability information does not include an indication of an amount of time for switching a transmit chain, antenna, and/or port from the first uplink transmission component carrier to the SRS component carrier, the network node would be unable to determine the SRS switching time for any case involving switching a transmit chain, antenna, and/or port from a non-source uplink transmission component carrier (e.g., an uplink transmission component carrier other than the second uplink transmission component carrier) directly to the SRS component carrier.

Further, in some cases, switching the number of transmit chains, antennas, and/or ports to the SRS component carrier may interrupt and/or prevent a simultaneous transmission of the SRS and another transmission (e.g., an uplink and/or downlink transmission that is transmitted at the same time as the SRS). In these cases, the capability information may be insufficient to enable the network node to determine that the simultaneous transmission of the SRS and the other transmission may be interrupted and/or prevented based at least in part on the UE switching the number of transmit chains, antennas, and/or ports to the SRS component carrier.

Various aspects relate generally to determining an SRS switching time based at least in part on an uplink transmission switching state and a number of transmit chains, antennas, and/or ports to be used to transmit an SRS via an SRS component carrier. As used herein, “uplink transmission switching state” may refer to a number of transmit chains, antennas, and/or ports associated with a component carrier, an uplink component carrier transmission group (e.g., a group of uplink transmission component carriers), and/or a frequency band. Some aspects more specifically relate to transmitting, to a network node, capability information that enables the network node to determine an SRS switching time for the UE. Some aspects may relate to communicating information indicating that the number of transmit chains, antennas, and/or ports are to be switched from the SRS component carrier to one or more uplink transmission component carriers after transmitting the SRS.

Particular aspects of the subject matter described in this disclosure can be implemented to realize one or more of the following potential advantages. In some examples, the described techniques can be used to determine an SRS switching time for a UE, whether switching one or more uplink transmission component carriers to an SRS component carrier will interrupt or prevent a simultaneous transmission, and/or one or more uplink transmission component carriers to which the transmit chains, antennas, and/or ports used to transmit the SRS are to be switched after a transmission of the SRS.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

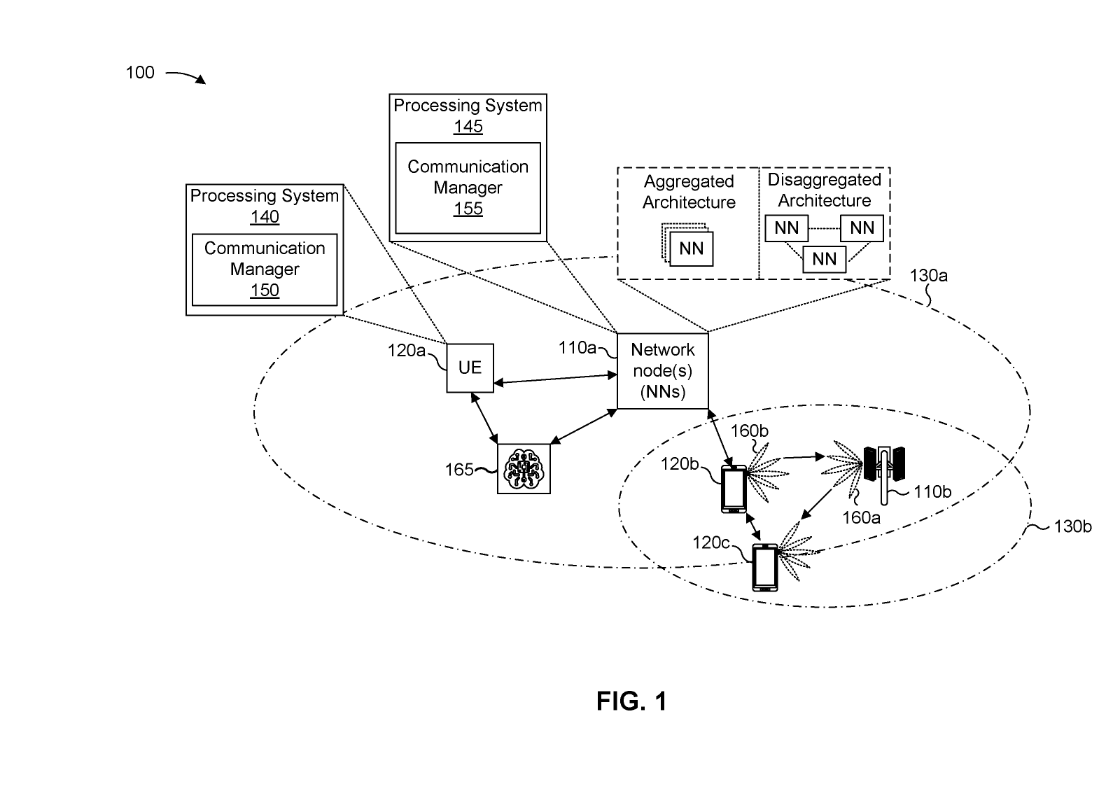

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

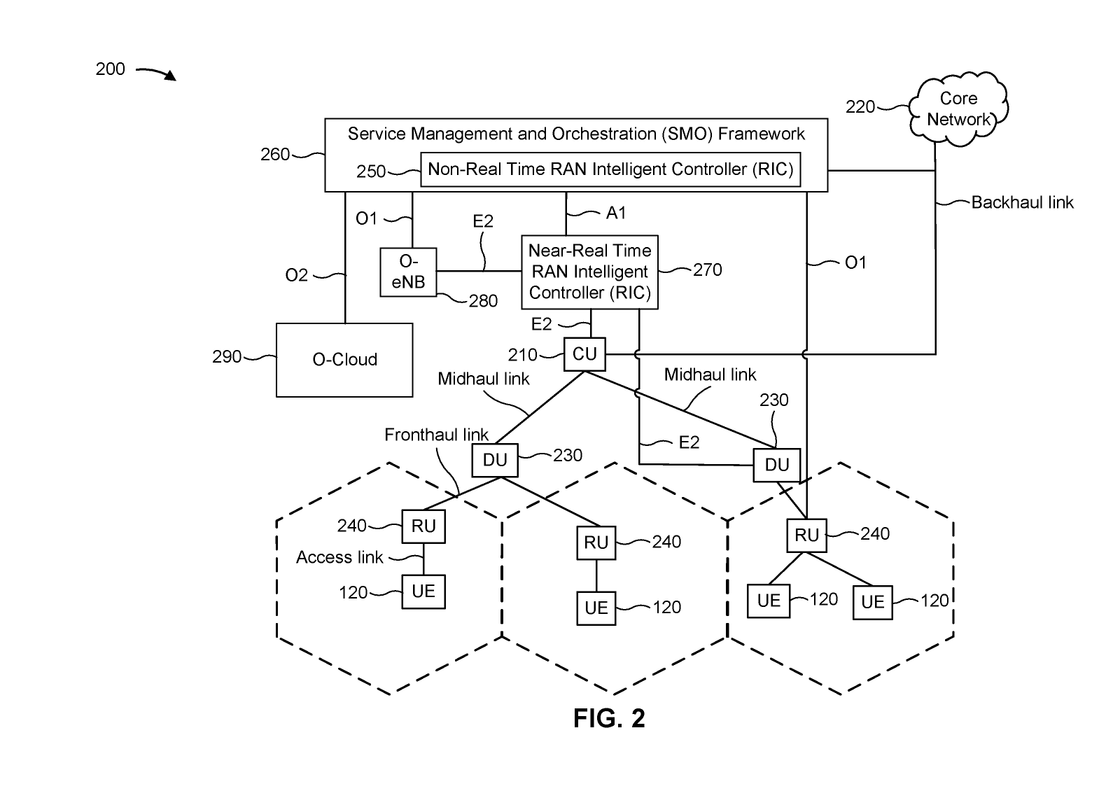

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a downlink reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include an uplink reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE 120 may include a communication manager 150. As described in more detail elsewhere herein, the communication manager 150 may transmit capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier; receive an indication to transmit an SRS in the SRS component carrier; and perform a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier. Additionally, or alternatively, the communication manager 150 may perform one or more other operations described herein.

In some aspects, a network node 110 may include a communication manager 155. As described in more detail elsewhere herein, the communication manager 155 may transmit, to a UE, a request for capability information; and receive the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, wherein a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

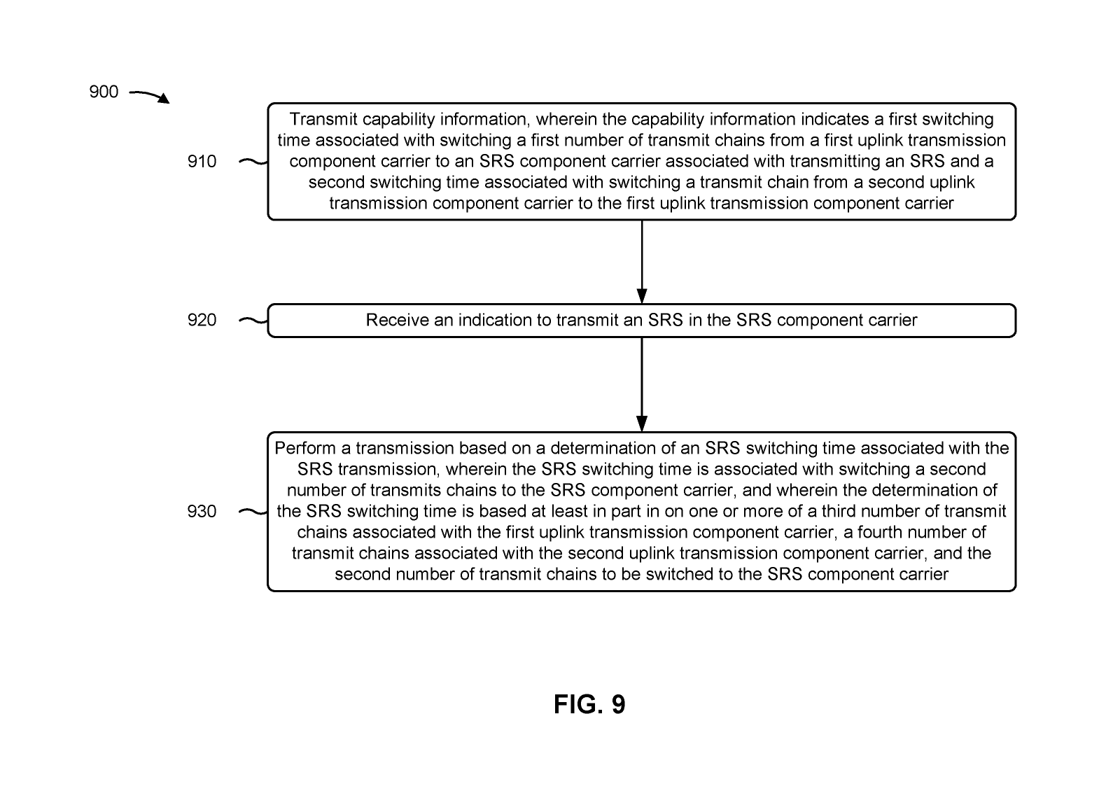

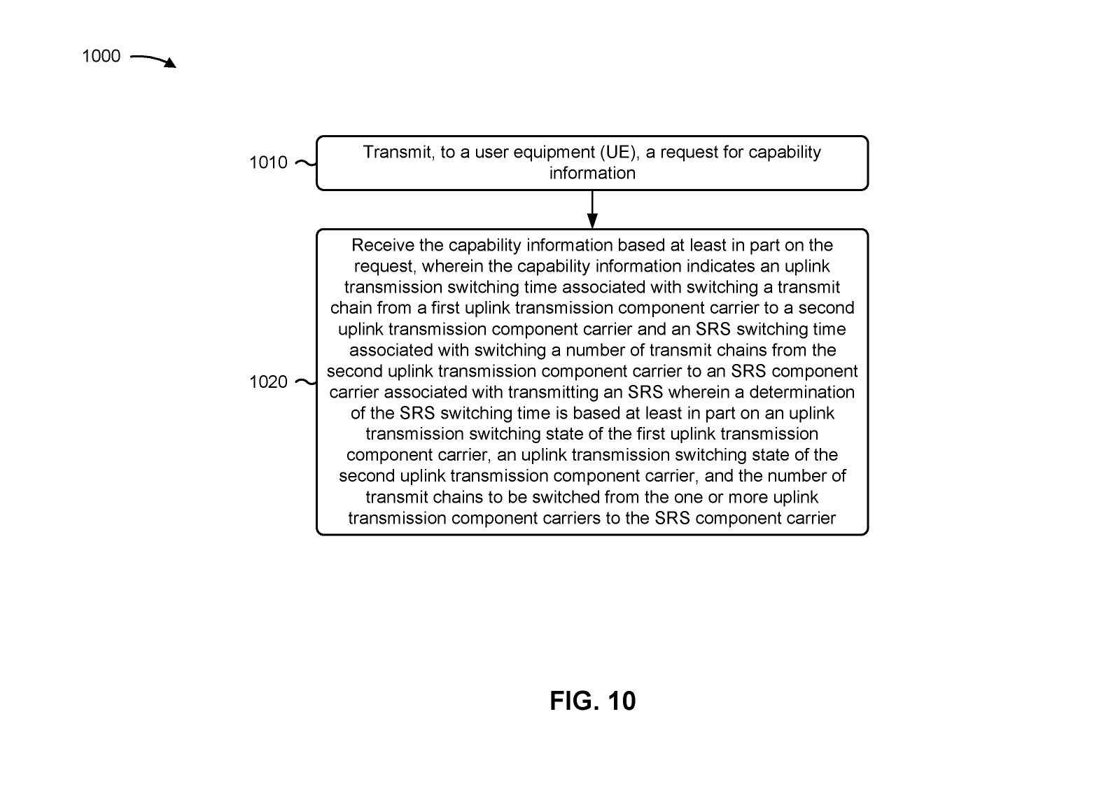

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with SRS carrier switching and uplink transmission switching, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

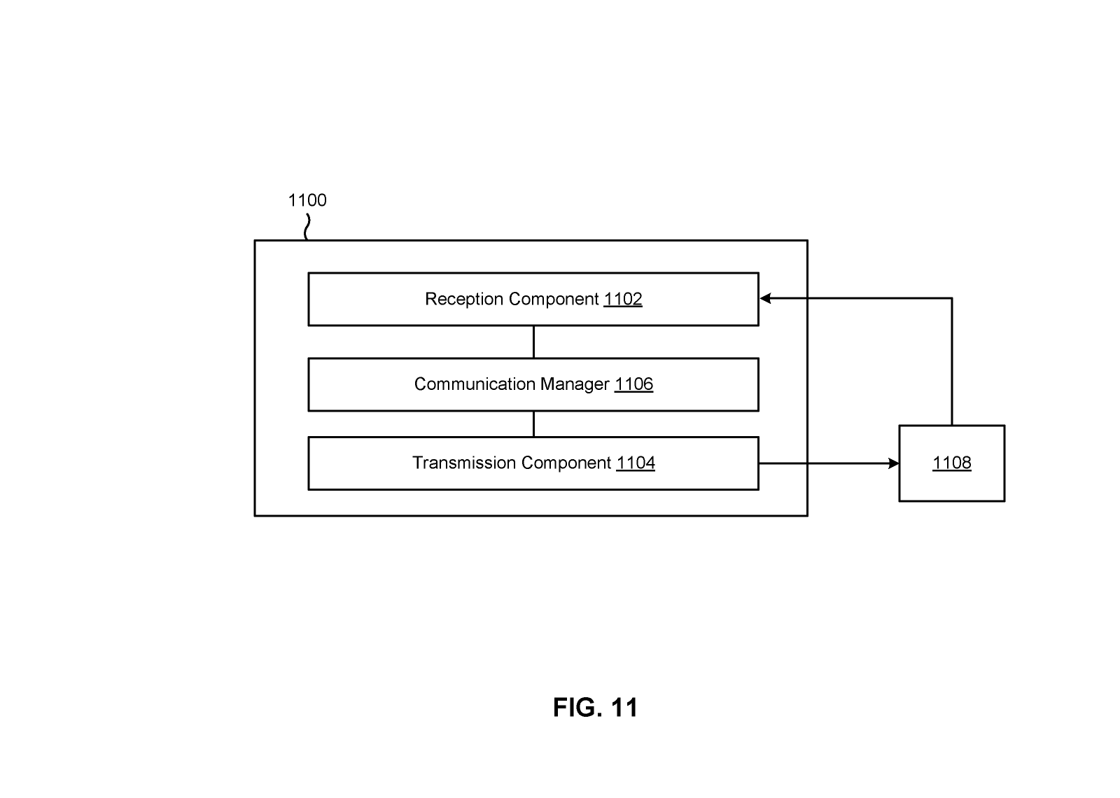

In some aspects, a UE includes means for transmitting capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier; means for receiving an indication to transmit an SRS in the SRS component carrier; and/or means for performing a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier. The means for the UE to perform operations described herein may include, for example, one or more of communication manager 150, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

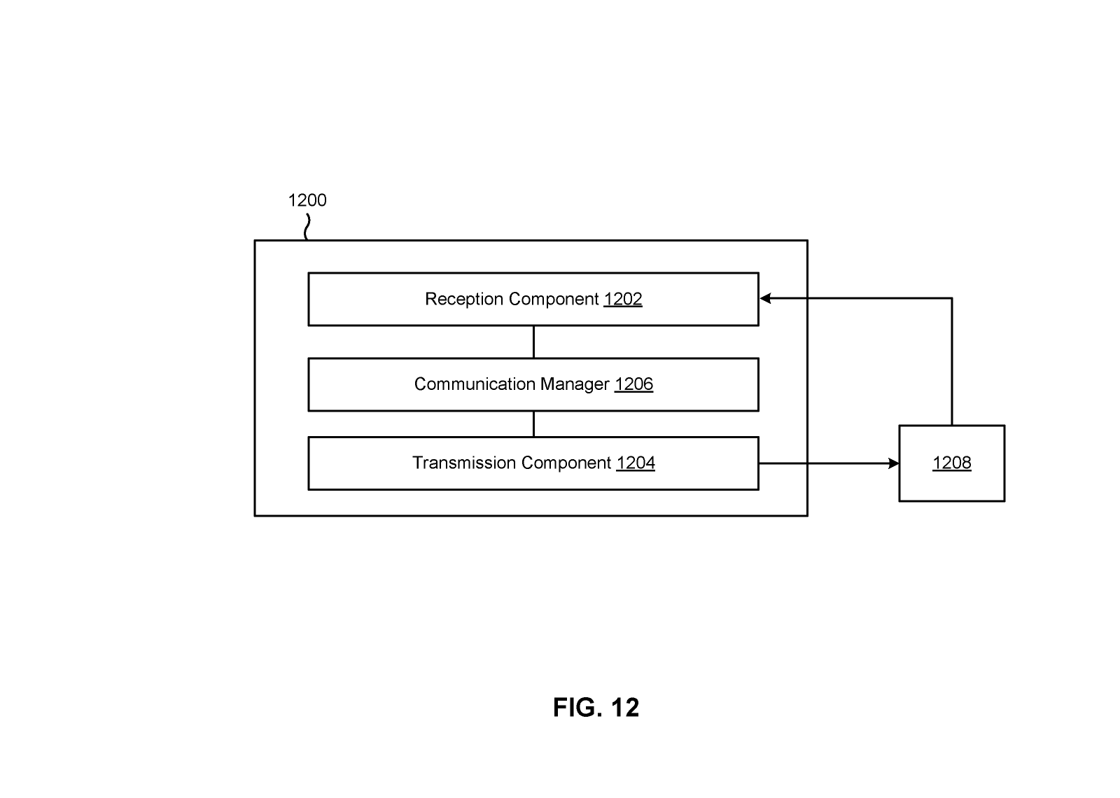

In some aspects, a network node includes means for transmitting, to a UE, a request for capability information; and/or means for receiving the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, wherein a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

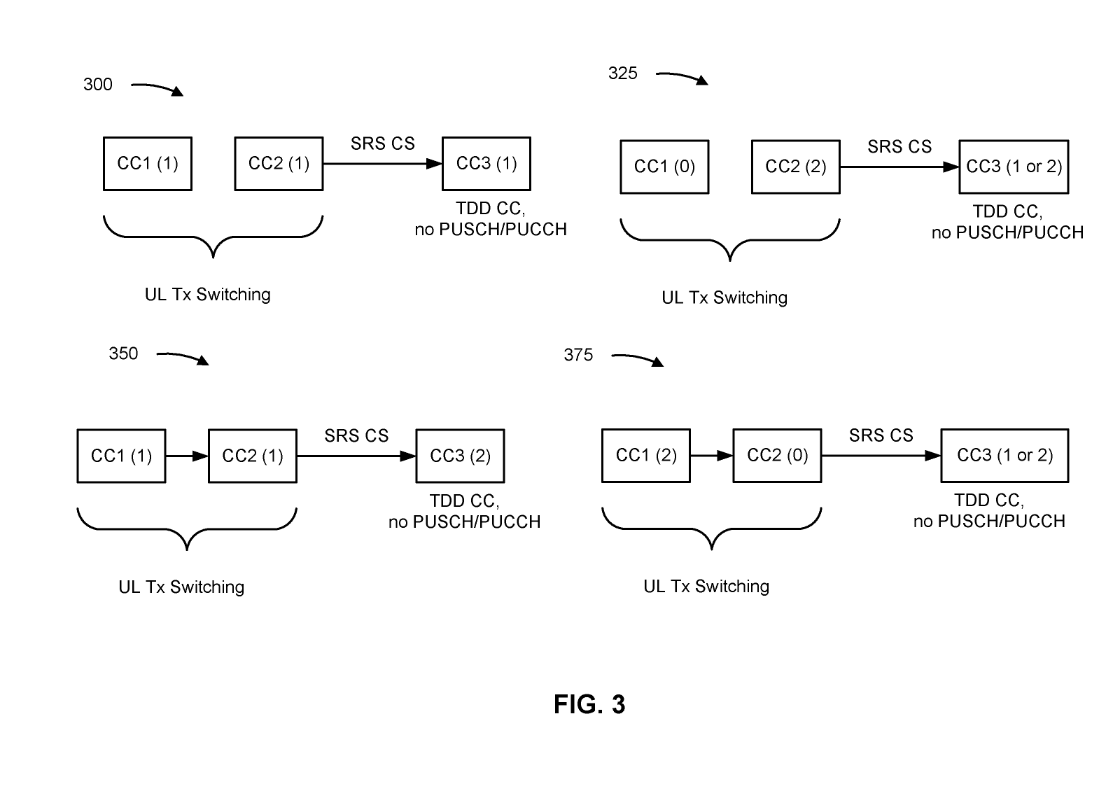

FIGS. 3-8 are diagrams illustrating examples associated with SRS carrier switching and uplink transmission switching, in accordance with the present disclosure.

FIG. 3 illustrates examples 300, 325, 350, and 375 associated with SRS carrier switching. In some aspects, an SRS switching time may depend on an uplink transmission switching state and a number of transmit chains, antennas, and/or ports to be used to transmit an SRS. As shown by example 300, a first uplink transmission component carrier (e.g., CC1, as shown in FIG. 3) and a second uplink transmission component carrier (e.g., CC2, as shown in FIG. 3) may be included in an uplink transmission switching group.

In some aspects, as shown by example 300, the uplink transmission switching group may have an uplink transmission switching state corresponding to the first uplink transmission component carrier being associated with one transmit chain, antenna, and/or port (indicated as “CC1 (1)” in FIG. 3) and the second uplink transmission component carrier being associated with one transmit chain, antenna, and/or port (indicated as “CC2 (1)” in FIG. 3).

In some aspects, a third component carrier (e.g., CC3, as shown in FIG. 3) may comprise an SRS component carrier. The SRS component carrier may comprise a component carrier that comprises uplink symbols and downlink symbols and is not associated with an uplink physical control channel (e.g., a PUCCH) or an uplink physical shared channel (e.g., a PUSCH). The SRS component carrier may be configured to utilize one transmit chain, antenna, and/or port to transmit an SRS (indicated as “CC3 (1)” in FIG. 3).

In some aspects, a UE (e.g., UE 120) may receive an indication to transmit an SRS. As shown in FIG. 3, the UE may switch a transmit chain, antenna, and/or port from the second uplink transmission component carrier to the SRS component carrier. In some aspects, the UE may switch the transmit chain, antenna, and/or port from the second uplink transmission component carrier to the SRS component carrier based at least in part on the second uplink transmission component carrier comprising a source uplink transmission component carrier. In these aspects, the SRS switching time may comprise an amount of time for the UE to switch the transmit chain, antenna, and/or port from the second uplink transmission component carrier to the SRS component carrier.

As shown by example 350, a first uplink transmission component carrier (e.g., CC1, as shown in FIG. 3) and a second uplink transmission component carrier (e.g., CC2, as shown in FIG. 3) may be included in an uplink transmission switching group. In some aspects, as shown by example 325, the uplink transmission switching group may have an uplink transmission switching state corresponding to the first uplink transmission component carrier being associated with no transmit chains, antennas, and/or ports (indicated as “CC1 (0)” in FIG. 3) and the second uplink transmission component carrier being associated with two transmit chains, antennas, and/or ports (indicated as “CC2 (2)” in FIG. 3).

In some aspects, a third component carrier (e.g., CC3, as shown in FIG. 3) may comprise an SRS component carrier. The SRS component carrier may comprise a component carrier that comprises uplink symbols and downlink symbols and is not associated with an uplink physical control channel (e.g., a PUCCH) or an uplink physical shared channel (e.g., a PUSCH). The SRS component carrier may be configured to utilize two transmit chains, antennas, and/or ports to transmit an SRS (indicated as “CC3 (2)” in FIG. 3). In some aspects, as shown in example 350, the second uplink transmission component carrier may not be associated with a sufficient number of transmit chains, antennas, and/or ports. In these aspects, the SRS switching time may be computed.

As shown in FIG. 3, the UE may switch a transmit chain, antenna, and/or port from first uplink transmission component carrier to the second uplink transmission component carrier and may switch two transmit chains, antennas, and/or ports from second uplink transmission component carrier to the SRS component carrier. In some aspects, the UE may switch the two transmit chains, antennas, and/or ports from the second uplink transmission component carrier to the SRS component carrier based at least in part on the second uplink transmission component carrier comprising a source uplink transmission component carrier.

In these aspects, the SRS switching time may comprise an amount of time for the UE to switch the transmit chain, antenna, and/or port from the first uplink transmission component carrier to the second uplink transmission component carrier plus an amount of time for the UE to switch the two transmit chains, antennas, and/or ports from the second uplink transmission component carrier to the SRS component carrier.

In some aspects, the UE may include a third uplink transmission component carrier (not shown). In these aspects, the SRS switching time may comprise the amount of time for the UE to switch the two transmit chains, antennas, and/or ports from the second uplink transmission component carrier to the SRS component carrier plus a maximum of the amount of time for the UE to switch the transmit chain, antenna, and/or port from the first uplink transmission component carrier to the second uplink transmission component carrier and an amount of time for the UE to switch the transmit chain, antenna, and/or port from the third uplink transmission component carrier to the second uplink transmission component carrier.

As shown by example 375, a first uplink transmission component carrier (e.g., CC1, as shown in FIG. 3) and a second uplink transmission component carrier (e.g., CC2, as shown in FIG. 3) may be included in an uplink transmission switching group.

In some aspects, the uplink transmission switching group may have an uplink transmission switching state corresponding to the first uplink transmission component carrier being associated with two transmit chains, antennas, and/or ports (indicated as “CC1 (2)” in FIG. 3) and the second uplink transmission component carrier being associated with no transmit chains, antennas, and/or ports (indicated as “CC2 (0)” in FIG. 3).

In some aspects, a third component carrier (e.g., CC3, as shown in FIG. 3) may comprise an SRS component carrier. The SRS component carrier may comprise a component carrier that comprises uplink symbols and downlink symbols and is not associated with an uplink physical control channel (e.g., a PUCCH) or an uplink physical shared channel (e.g., a PUSCH). The SRS component carrier may be configured to utilize one or two transmit chains, antennas, and/or ports to transmit an SRS (indicated as “CC3 (1 or 2)” in FIG. 3).

In some aspects, a UE (e.g., UE 120) may receive an indication to transmit an SRS. In some aspects, as shown in example 375, the second uplink transmission component carrier may not be associated with a sufficient number of transmit chains, antennas, and/or ports.

As shown in FIG. 3, the UE may switch one or two transmit chains, antennas, and/or ports from first uplink transmission component carrier to the second uplink transmission component carrier and may switch one or two transmit chains, antennas, and/or ports from second uplink transmission component carrier to the SRS component carrier. In some aspects, the UE may switch the two transmit chains, antennas, and/or ports from the second uplink transmission component carrier to the SRS component carrier based at least in part on the second uplink transmission component carrier comprising a source uplink transmission component carrier.

In these aspects, the SRS switching time may comprise an amount of time for the UE to switch the one or two transmit chains, antennas, and/or ports from the first uplink transmission component carrier to the second uplink transmission component carrier plus an amount of time for the UE to switch the two transmit chains, antennas, and/or ports from the second uplink transmission component carrier to the SRS component carrier.

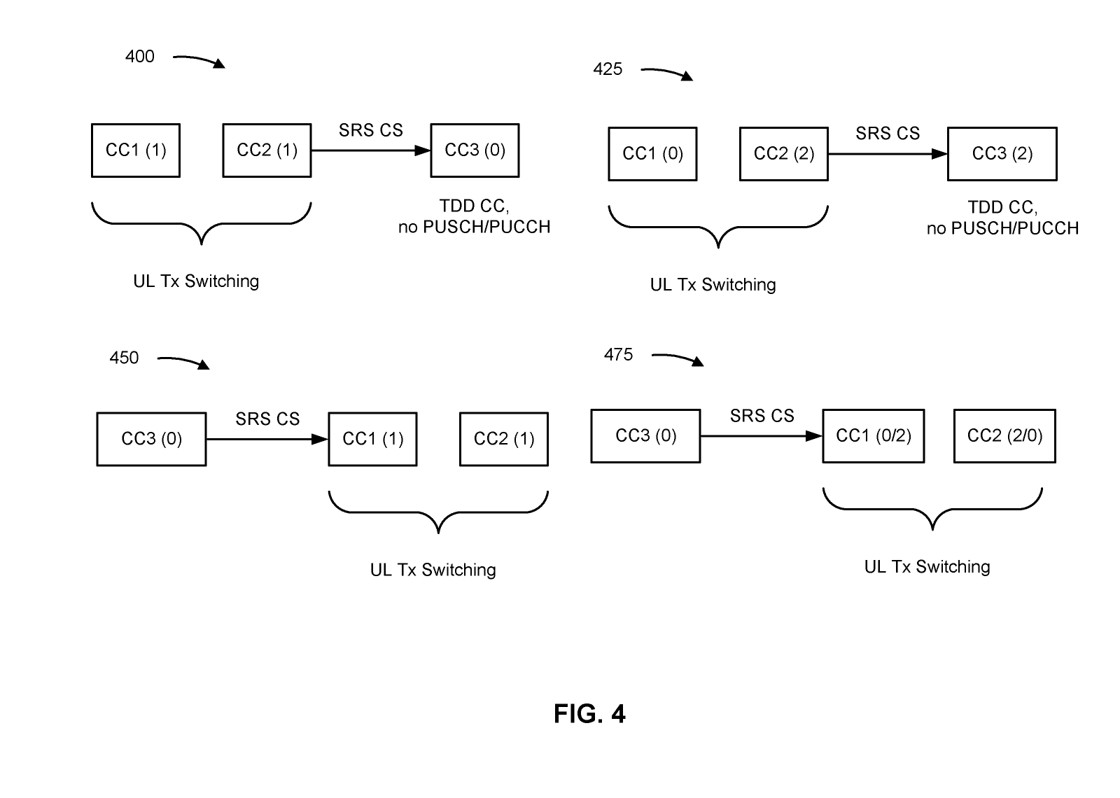

FIG. 4 illustrates an example associated with switching transmit chains, antennas, and/or ports from one or more uplink transmission component carriers to an SRS component carrier and, after transmitting an SRS, switching the one or more transmit chains, antennas, and/or ports from the SRS component carrier to one or more uplink transmission component carriers.

As shown by reference number 400, a first uplink transmission component carrier (e.g., CC1, as shown in FIG. 4) and a second uplink transmission component carrier (e.g., CC2, as shown in FIG. 4) may be included in an uplink transmission switching group.

In some aspects, the uplink transmission switching group may have an uplink transmission switching state corresponding to the first uplink transmission component carrier being associated with one transmit chain, antenna, and/or port (indicated as “CC1 (1)” in FIG. 4) and the second uplink transmission component carrier being associated with one transmit chain, antenna, and/or port (indicated as “CC2 (1)” in FIG. 4).

In some aspects, a third component carrier (e.g., CC3, as shown in FIG. 4) may comprise a SRS component carrier. The SRS component carrier may comprise a component carrier that comprises uplink symbols and downlink symbols and is not associated with an uplink physical control channel (e.g., a PUCCH) or an uplink physical shared channel (e.g., a PUSCH). The SRS component carrier may be configured to utilize two transmit chains, antennas, and/or ports to transmit an SRS.

In some aspects, a UE (e.g., UE 120) may receive an indication to transmit an SRS. In some aspects, the second uplink transmission component carrier may not be associated with a sufficient number of transmit chains, antennas, and/or ports.

As shown by reference number 425, the UE may switch one transmit chain, antenna, and/or port from first uplink transmission component carrier to the second uplink transmission component carrier and may switch two transmit chain, antenna, and/or port from second uplink transmission component carrier to the SRS component carrier. In some aspects, the UE may switch the two transmit chains, antennas, and/or ports from the second uplink transmission component carrier to the SRS component carrier based at least in part on the second uplink transmission component carrier comprising a source uplink transmission component carrier.

In some aspects, after transmitting an SRS, the UE may switch the two transmit chains, antennas, and/or ports from the SRS component carrier to one or more uplink transmission component carriers. In some aspects, as shown by reference number 450, the UE may cause the uplink transmission switching group to return to the uplink transmission switching state prior to the transmission of the SRS (e.g., the uplink transmission switching state corresponding to the first uplink transmission component carrier being associated with one transmit chain, antenna, and/or port and the second uplink transmission component carrier being associated with one transmit chain, antenna, and/or port).

In some aspects, as shown by reference number 475, the UE may cause the uplink transmission switching group to correspond to a uplink transmission switching state which is different from the uplink transmission switching state prior to the transmission of the SRS. For example, the UE may switch two transmit chains, antennas, and/or ports from the SRS component carrier to the second uplink transmission component. As another example, the UE may switch two transmit chains, antennas, and/or ports from the SRS component carrier to the second uplink transmission component and then switch two transmit chains, antennas, and/or ports from the second uplink transmission component to the first uplink transmission component carrier.

In some aspects, the uplink transmission switching state after transmission of the SRS may be configured by a network node. For example, a network node may transmit, and the UE may receive signaling (e.g. RRC signaling) indicating the uplink transmission switching state to which the UE is to return after transmission of an SRS.

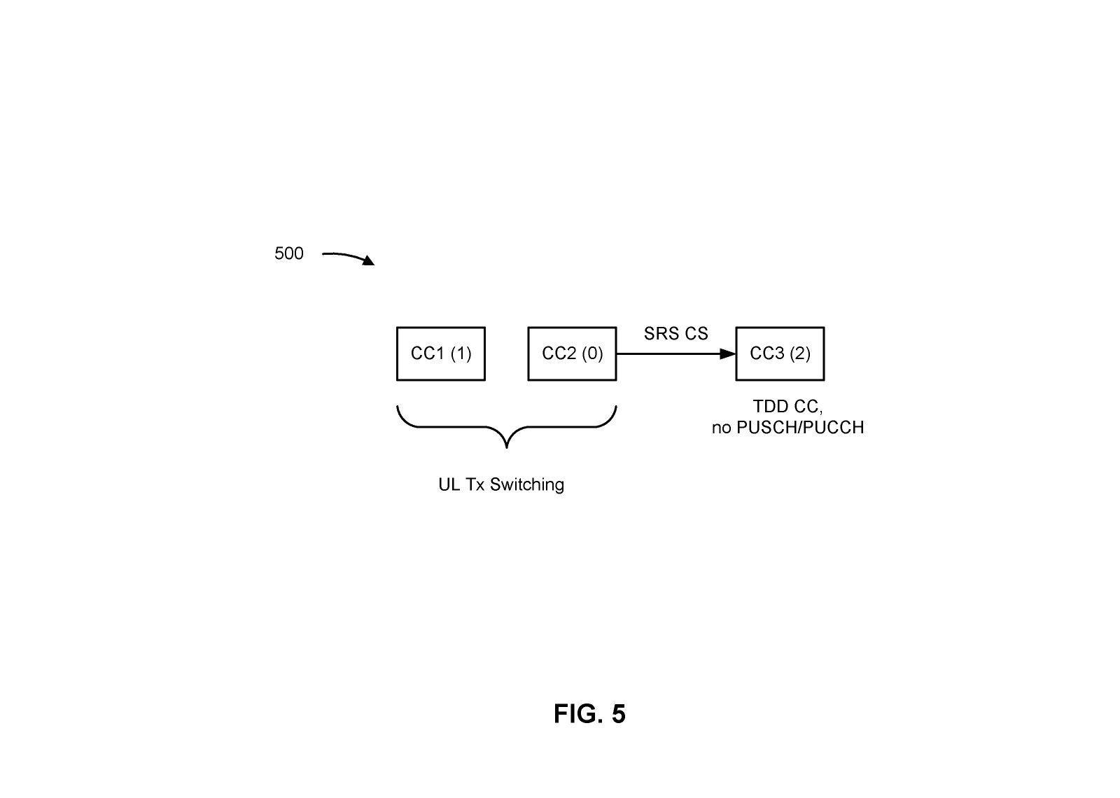

FIG. 5 illustrates an example 500 associated with simultaneous transmission and prioritization.

In some aspects, a UE (e.g., a UE 120) may transmit information indicating uplink transmission component carriers included in the uplink transmission switching group that are interrupted when the UE perform SRS carrier switching. In some aspects, the uplink transmission component carriers that are interrupted may be different for different uplink transmission switching states. In some aspects, the uplink transmission component carriers that are interrupted may be different for uplink and downlink communications.

As shown by reference number 500, a first uplink transmission component carrier (e.g., CC1, as shown in FIG. 5) and a second uplink transmission component carrier (e.g., CC2, as shown in FIG. 5) may be included in an uplink transmission switching group.

In some aspects, the first uplink transmission component carrier may be scheduled to transmit an uplink communication with one transmit chain, antenna, and/or port (indicated as “CC1 (1)” in FIG. 5) and the second uplink transmission component carrier may not be scheduled to transmit an uplink communication (indicated as “CC2 (0)” in FIG. 5).

In some aspects, a third component carrier (e.g., CC3, as shown in FIG. 5) may comprise a SRS component carrier. The SRS component carrier may comprise a component carrier that comprises uplink symbols and downlink symbols and is not associated with an uplink physical control channel (e.g., a PUCCH) or an uplink physical shared channel (e.g., a PUSCH). The SRS component carrier may be configured to utilize two transmit chains, antennas, and/or ports to transmit an SRS.

In some aspects, simultaneous transmission across the first uplink transmission component carrier and the third uplink transmission component carrier may be supported but the UE may not have enough transmit chains, antennas, and/or ports to perform the transmission in both the first uplink transmission component carrier and the third uplink transmission component carrier simultaneously. In some aspects, the UE may perform prioritization between the first uplink transmission component carrier and the third uplink transmission component carrier.

In some aspects, the UE may perform prioritization based at least in part on the type of data being communicated. For example, if the first uplink transmission component carrier is scheduled to transmit HARQ feedback, the UE may prioritize the first uplink transmission component carrier over the SRS component carrier. As another example, if the first uplink transmission component carrier is scheduled to transmit a PUSCH communication with CQI/PMI only, the UE may prioritize the SRS component carrier over the first uplink transmission component carrier.

In some aspects, the UE may add a uplink transmission component carrier to the group of component carriers for which prioritization is performed based at least in part on a sum of a quantity of ports associated with transmitting an SRS and a quantity of ports scheduled for a uplink transmission component carrier exceeding a simultaneous transmission capability of the UE (e.g., 2).

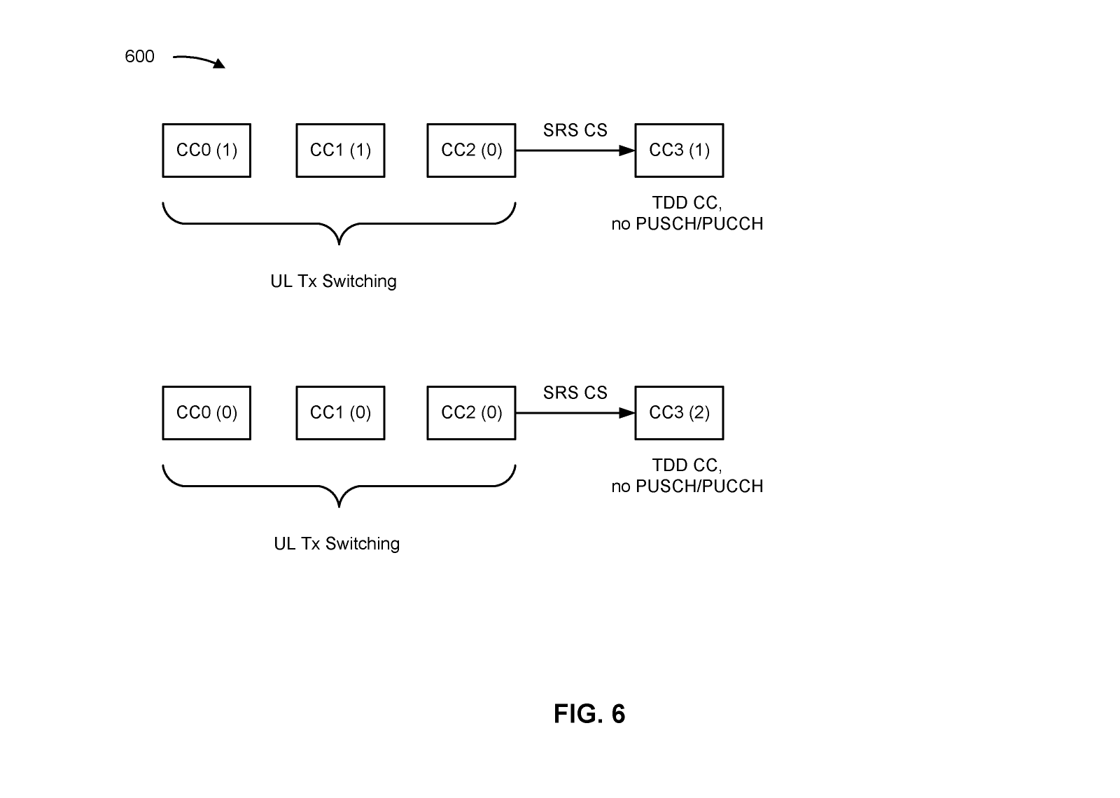

FIG. 6 illustrates example 600 associated with switching transmit chains, antennas, and/or ports from a plurality of non-source uplink transmission component carriers.

In some aspects, an SRS switching time may depend on an uplink transmission switching state (e.g., a state of the uplink transmission switching group) and a number of transmit chains, antennas, and/or ports to be used to transmit an SRS. As shown by example 600, a fourth uplink transmission component carrier (e.g., CC0, as shown in FIG. 6), a first uplink transmission component carrier (e.g., CC1, as shown in FIG. 6), and a second uplink transmission component carrier (e.g., CC2, as shown in FIG. 6) may be included in an uplink transmission switching group.

In some aspects, the uplink transmission switching group may have an uplink transmission switching state corresponding to the fourth uplink transmission component carrier being associated with one transmit chain, antenna, and/or port (indicated as “CC0 (1)” in FIG. 6), the first uplink transmission component carrier being associated with one transmit chain, antenna, and/or port (indicated as “CC1 (1)” in FIG. 6), and the second uplink transmission component carrier being associated with no transmit chains, antennas, and/or ports (indicated as “CC2 (0)” in FIG. 6).

In some aspects, a third component carrier (e.g., CC3, as shown in FIG. 6) may comprise an SRS component carrier. The SRS component carrier may comprise a component carrier that comprises uplink symbols and downlink symbols and is not associated with an uplink physical control channel (e.g., a PUCCH) or an uplink physical shared channel (e.g., a PUSCH). The SRS component carrier may be configured to utilize one transmit chain, antenna, and/or port to transmit an SRS (indicated as “CC3 (1)” in FIG. 6).

In some aspects, the SRS switching time may be based at least in part on a worst case or maximum amount of time for switching a transmit chain, antenna, and/or port from an uplink transmission component carrier to the SRS component carrier. For example, the SRS switching time may be a sum of an amount of time to switch one transmit chain, antenna, and/or port from the third uplink transmission component carrier to the SRS component carrier and a maximum of an amount of time to switch one transmit chain, antenna, and/or port from the fourth uplink transmission component carrier to the second uplink transmission component carrier and an amount of time to switch one transmit chain, antenna, and/or port from the first uplink transmission component carrier to the second uplink transmission component carrier.

In some aspects, the UE may transmit information indicating the SRS switching time to a network node (e.g., the sum of the amount of time to switch one transmit chain, antenna, and/or port from the second uplink transmission component carrier to the SRS component carrier and the maximum of the amount of time to switch one transmit chain, antenna, and/or port from the fourth uplink transmission component carrier to the second uplink transmission component carrier and the amount of time to switch one transmit chain, antenna, and/or port from the first uplink transmission component carrier to the second uplink transmission component carrier). In some aspects, the UE may transmit information indicating an amount of time to switch one transmit chain, antenna, and/or port from the fourth uplink transmission component carrier to the SRS component carrier and information indicating an amount of time to switch one transmit chain, antenna, and/or port from the first uplink transmission component carrier to the SRS component carrier.

In some aspects, the UE determines whether to switch the one transmit chain, antenna, and/or port from the fourth uplink transmission component carrier to the SRS component carrier or to switch the one transmit chain, antenna, and/or port from the first uplink transmission component carrier to the SRS component carrier based at least in part on the smallest SRS switching time. For example, the UE may determine to switch the one transmit chain, antenna, and/or port from the first uplink transmission component carrier to the SRS component carrier (rather than switching the one transmit chain, antenna, and/or port from the fourth uplink transmission component carrier to the SRS component carrier) based at least in part on the amount of time to switch the one transmit chain, antenna, and/or port from the first uplink transmission component carrier to the SRS component carrier being less than the amount of time to switch the one transmit chain, antenna, and/or port from the fourth uplink transmission component carrier to the SRS component carrier.

In some aspects, the UE determines whether to switch the one transmit chain, antenna, and/or port from the fourth uplink transmission component carrier to the SRS component carrier or to switch the one transmit chain, antenna, and/or port from the first uplink transmission component carrier to the SRS component carrier based at least in part on a priority associated with the fourth uplink transmission component carrier and a priority associated with the first uplink transmission component carrier. In some aspects, the priority associated with the fourth uplink transmission component carrier and the priority associated with the first uplink transmission component carrier may be received from a network node (e.g., via RRC signaling).

In some aspects, the priority associated with the fourth uplink transmission component carrier and the priority associated with the first uplink transmission component carrier may be determined by the UE. For example, the UE may determine a priority associated with the fourth uplink transmission component carrier and a priority associated with the first uplink transmission component carrier based at least in part on a cell index associated with the fourth uplink transmission component carrier and a cell index associated with the first uplink transmission component carrier, respectively.

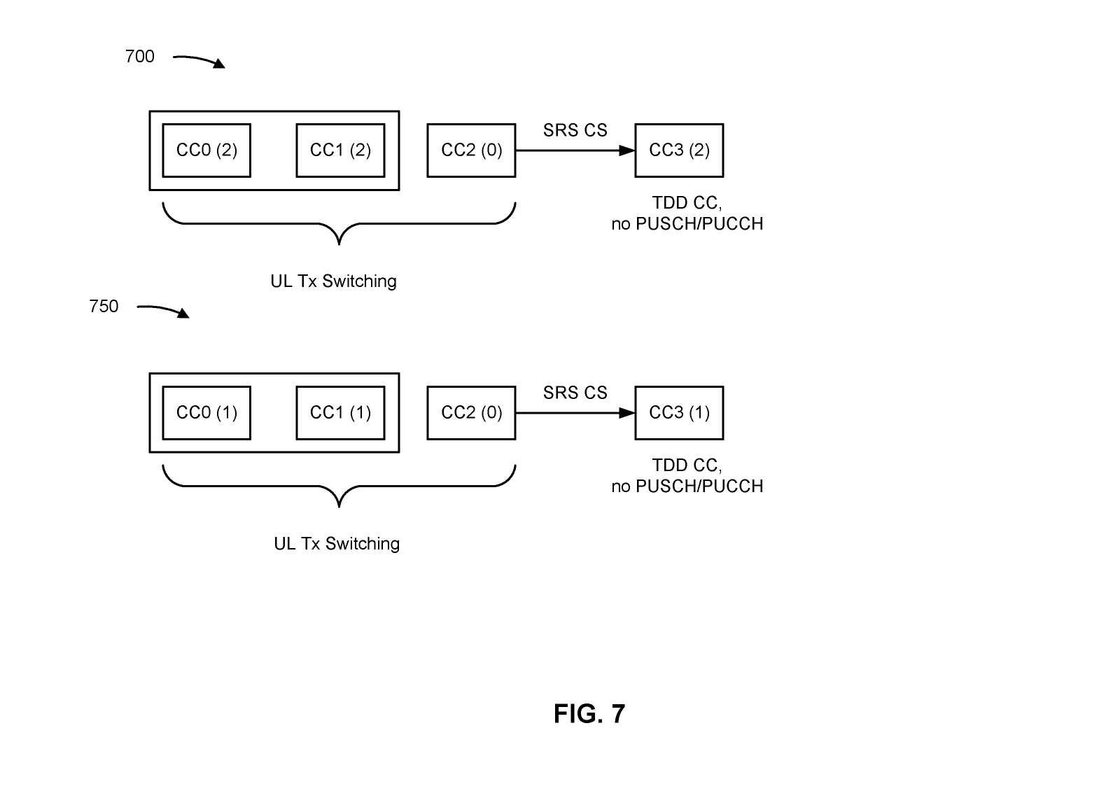

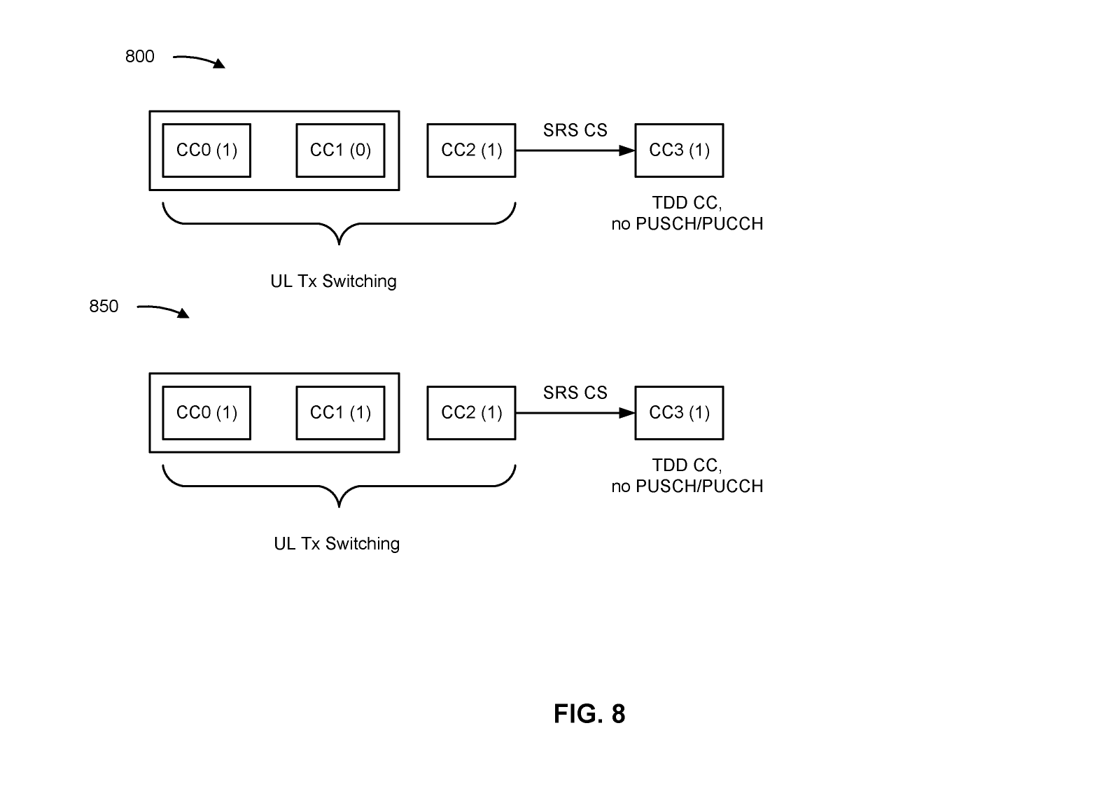

FIGS. 7 and 8 illustrate examples 700, 750, 800, and 850 associated with simultaneous transmission and prioritization.

As shown by example 700, a fourth uplink transmission component carrier (e.g., CC0, as shown in FIG. 7), a first uplink transmission component carrier (e.g., CC1, as shown in FIG. 7), and a second uplink transmission component carrier (e.g., CC2, as shown in FIG. 7) may be included in an uplink transmission switching group.

In some aspects, the fourth uplink transmission component carrier and the first uplink transmission component carrier may be in-band aggregated and may be scheduled to perform a transmission with two transmit chains, antennas, and/or ports (indicated as “CC0 (2)” and “CC1 (2)” in FIG. 7), the second uplink transmission component carrier may not be scheduled to perform a transmission (indicated as “CC2 (0)” in FIG. 7), and a third component carrier (e.g., CC3, as shown in FIG. 7) may comprise a SRS component carrier that is scheduled to transmit an SRA using two transmit chains, antennas, and/or ports to transmit an SRS (indicated as “CC3 (2)” in FIG. 7).

In some aspects, the total quantity of ports for performing simultaneous transmissions may exceed a capability of the UE. In these aspects, the UE may perform prioritization between the SRS component carrier and the in-band aggregated component carriers.

As shown by example 750, a fourth uplink transmission component carrier (e.g., CC0, as shown in FIG. 7), a first uplink transmission component carrier (e.g., CC1, as shown in FIG. 7), and a second uplink transmission component carrier (e.g., CC2, as shown in FIG. 7) may be included in an uplink transmission switching group.

In some aspects, the fourth uplink transmission component carrier and the first uplink transmission component carrier may be in-band aggregated and may be scheduled to perform a transmission with one transmit chain, antenna, and/or port (indicated as “CC0 (1)” and “CC1 (1)” in FIG. 7), the second uplink transmission component carrier may not be scheduled to perform a transmission (indicated as “CC2 (0)” in FIG. 7), and a third component carrier (e.g., CC3, as shown in FIG. 7) may comprise a SRS component carrier that is scheduled to transmit an SRA using one transmit chain, antenna, and/or port to transmit an SRS (indicated as “CC3 (1)” in FIG. 7).

In some aspects, the total quantity of ports for performing simultaneous transmissions may not exceed a capability of the UE. In these aspects, the UE may perform simultaneous transmissions with respect to the SRS component carrier and the in-band aggregated component carriers.

As shown in FIG. 8, and by example 800, a fourth uplink transmission component carrier (e.g., CC0, as shown in FIG. 8), a first uplink transmission component carrier (e.g., CC1, as shown in FIG. 8), and a second uplink transmission component carrier (e.g., CC2, as shown in FIG. 8) may be included in an uplink transmission switching group.

In some aspects, the fourth uplink transmission component carrier and the first uplink transmission component carrier may be in-band aggregated and the fourth uplink transmission component carrier may be scheduled to perform a transmission with one transmit chain, antenna, and/or port (indicated as “CC0 (1)” and “CC1 (0)” in FIG. 8), the second uplink transmission component carrier may be scheduled to perform a transmission with one transmit chain, antenna, and/or port (indicated as “CC2 (1)” in FIG. 8), and a third component carrier (e.g., CC3, as shown in FIG. 8) may comprise a SRS component carrier that is scheduled to transmit an SRA using one transmit chain, antenna, and/or port to transmit an SRS (indicated as “CC3 (1)” in FIG. 8).

In some aspects, the total quantity of ports for performing simultaneous transmissions may exceed a capability of the UE. In these aspects, the UE may perform prioritization between the SRS component carrier, the first uplink transmission component carrier, and the in-band aggregated component carriers.

As shown in FIG. 8, and by example 850, a fourth uplink transmission component carrier (e.g., CC0, as shown in FIG. 8), a first uplink transmission component carrier (e.g., CC1, as shown in FIG. 8), and a second uplink transmission component carrier (e.g., CC2, as shown in FIG. 8) may be included in an uplink transmission switching group.

In some aspects, the fourth uplink transmission component carrier and the first uplink transmission component carrier may be in-band aggregated and may be scheduled to perform a transmission with one transmit chain, antenna, and/or port (indicated as “CC0 (1)” and “CC1 (1)” in FIG. 8), the second uplink transmission component carrier may be scheduled to perform a transmission with one transmit chain, antenna, and/or port (indicated as “CC2 (1)” in FIG. 8), and a third component carrier (e.g., CC3, as shown in FIG. 8) may comprise a SRS component carrier that is scheduled to transmit an SRS using one transmit chain, antenna, and/or port to transmit an SRS (indicated as “CC3 (1)” in FIG. 8).

In some aspects, the total quantity of ports for performing simultaneous transmissions may exceed a capability of the UE. In these aspects, the UE may perform prioritization between the SRS component carrier, the first uplink transmission component carrier, and the in-band aggregated component carriers.

As indicated above, FIGS. 3-8 are provided as examples. Other examples may differ from what is described with respect to FIGS. 3-8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with techniques for SRS carrier switching and uplink transmission switching.

As shown in FIG. 9, in some aspects, process 900 may include transmitting capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier (block 910). For example, the UE (e.g., using transmission component 1104 and/or communication manager 1106, depicted in FIG. 11) may transmit capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier, as described above.

As further shown in FIG. 9, in some aspects, process 900 may include receiving an indication to transmit an SRS in the SRS component carrier (block 920). For example, the UE (e.g., using reception component 1102 and/or communication manager 1106, depicted in FIG. 11) may receive an indication to transmit an SRS in the SRS component carrier, as described above.

As further shown in FIG. 9, in some aspects, process 900 may include performing a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier (block 930). For example, the UE (e.g., using communication manager 1106, depicted in FIG. 11) may perform a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier, as described above.

Process 900 may include additional aspects, such as any single aspect or any combination of aspects described below and/or in connection with one or more other processes described elsewhere herein.

In a first aspect, the SRS switching time corresponds to a sum of a first amount of time and a second amount of time, wherein the first amount of time corresponds to an amount of time associated with switching a transmit chain from the first uplink transmission component carrier to the SRS component carrier and the second amount of time corresponds to the second capability switching time.

In a second aspect, the capability information indicates the first amount of time and the second amount of time.

In a third aspect, the SRS switching time corresponds to a sum of a first amount of time and a second amount of time, wherein the first amount of time corresponds to an amount of time associated with switching a transmit chain from the first uplink transmission component carrier to the SRS component carrier and the second amount of time corresponds to maximum of an amount of time to switch a transmit chain from the second uplink transmission component carrier to the first uplink transmission component carrier and an amount of time to switch a transmit chain from a third uplink transmission component carrier to the first uplink transmission component carrier.

In a fourth aspect, the capability information indicates the first amount of time and the second amount of time.

In a fifth aspect, the SRS switching time corresponds to a sum of the first capability switching time and the second capability switching time based at least in part on the capability information not indicating a third capability switching time associated with switching a transmit chain from the second uplink transmission component carrier to the SRS component carrier.

In a sixth aspect, the capability information further indicates a third capability switching time associated with switching a transmit chain from a third uplink transmission component carrier to the first uplink transmission component carrier.

In a seventh aspect, the third capability switching time is different from the second capability switching time.

In an eighth aspect, the capability information further indicates a third capability switching time associated with switching a transmit chain from the second uplink transmission component carrier to the SRS component carrier, and the determination of the SRS switching time associated with the SRS transmission is further based at least in part on the third capability switching time.

In a ninth aspect, the SRS switching time corresponds to a maximum of the first capability switching time and the third capability switching time.

In a tenth aspect, the capability information further indicates a third capability switching time associated with switching, in parallel, a transmit chain from the first uplink transmission component carrier to the SRS component carrier and a transmit chain from the second uplink transmission component carrier to the SRS component carrier, and the determination of the SRS switching time associated with the SRS transmission is further based at least in part on the third capability switching time.

In an eleventh aspect, an initial number of transmit chains associated with the first uplink transmission component carrier prior to transmitting the SRS and an initial number of transmit chains associated with the second uplink transmission component carrier prior to transmitting the SRS corresponds to a first uplink transmission switching state, and process 900 includes transmitting the SRS based at least in part on switching, to the SRS component carrier, one or more transmit chains from the first uplink transmission component carrier and/or the second uplink transmission component carrier, and causing the one or more transmit chains to switch from the SRS component carrier to the first uplink transmission component carrier and/or the second uplink transmission component carrier in accordance with the first uplink transmission switching state.

In a twelfth aspect, a first initial number of transmit chains associated with the first uplink transmission component carrier prior to transmitting the SRS and a second initial number of transmit chains associated with the second uplink transmission component carrier prior to transmitting the SRS corresponds to a first uplink transmission switching state, and process 900 includes transmitting the SRS based at least in part on switching, to the SRS component carrier, one or more transmit chains from the first uplink transmission component carrier and/or the second uplink transmission component carrier, and causing the one or more transmit chains to switch from the SRS component carrier to the second uplink transmission component carrier in accordance with a second uplink transmission switching state, wherein the second uplink transmission switching state corresponds to the first uplink transmission component carrier being associated with a first subsequent number of transmit chains and the second uplink transmission component carrier being associated with a second subsequent number of transmit chains, and wherein the first subsequent number of transmit chains is different from the first initial number of transmit chains, the second subsequent number of transmit chains is different from the second initial number of transmit chains, or a combination thereof.

In a thirteenth aspect, one or more of the first uplink transmission switching state or the second uplink transmission switching state is configured by a network node.

In a fourteenth aspect, process 900 includes transmitting the SRS based at least in part on switching, to the SRS component carrier, one or more transmit chains from the first uplink transmission component carrier and/or the second uplink transmission component carrier, and causing the one or more transmit chains to be switched from the SRS component carrier to a third uplink transmission component carrier based at least in part on transmitting the SRS.

In a fifteenth aspect, process 900 includes transmitting capability information indicating one or more uplink transmission component carriers in an uplink transmission component carrier switching group that are interrupted based at least in part on switching a transmit chain to the SRS component carrier.

In a sixteenth aspect, the information includes a separate indication for each of a plurality of uplink transmission component carriers included in the uplink transmission component carrier switching group.

In a seventeenth aspect, the information includes a first indication associated with a downlink communication channel and a second indication associated with an uplink communication channel.

In an eighteenth aspect, the capability information indicates that simultaneous transmissions across the SRS component carrier and the first uplink transmission component carrier are supported by the UE, and a number of transmit chains of the UE is insufficient to perform the simultaneous transmissions across the SRS component carrier and the first uplink transmission component carrier, and process 900 includes transmitting the SRS via the SRS component carrier or an uplink transmission via the first uplink transmission component carrier based at least in part on a priority associated with the SRS component carrier, a priority associated with the first uplink transmission component carrier, and a prioritization rule.

In a nineteenth aspect, the prioritization rule indicates that the priority associated with the first uplink transmission component carrier is a higher priority relative to the priority associated with the SRS component carrier based at least in part on a message to be transmitted via the first uplink transmission component carrier comprising a hybrid automatic repeat request (HARQ) acknowledgement (ACK).

In a twentieth aspect, the first uplink transmission component carrier is associated with a first frequency band and the second uplink transmission component carrier is associated with a second frequency band, and the capability information further indicates a maximum of the uplink transmission switching time associated with switching the transmit chain from the first uplink transmission component carrier to the second uplink transmission component carrier and an uplink transmission switching time associated with switching a transmit chain from a third uplink transmission component carrier in a third frequency band to the second uplink transmission component carrier.

In a twenty-first aspect, the first uplink transmission component carrier is associated with a first frequency band and the second uplink transmission component carrier is associated with a second frequency band, and the determination of the SRS switching time is based at least in part on a maximum of the second capability switching time and a third capability switching time associated with switching a transmit chain from a third uplink transmission component carrier in a third frequency band to the second uplink transmission component carrier.

In a twenty-second aspect, a number of transmit chains associated with the second uplink transmission component carrier is less than a number of transmit chains associated with transmitting the SRS via the SRS component carrier, and process 900 includes switching one or more transmit chains from the first uplink transmission component carrier or a third uplink transmission component carrier based at least in part on an amount of time associated with switching a transmit chain from the first uplink transmission component carrier to the SRS component carrier and an amount of time associated with switching a transmit chain from the third uplink transmission component carrier to the SRS component carrier.

In a twenty-third aspect, a number of transmit chains associated with the second uplink transmission component carrier is less than a number of transmit chains associated with transmitting the SRS via the SRS component carrier, and process 900 includes switching one or more transmit chains from the first uplink transmission component carrier or a third uplink transmission component carrier based at least in part on one or more of a priority associated with the first uplink transmission component carrier and a priority associated with the third uplink transmission component carrier, a cell index associated with the first uplink transmission component carrier and a cell index associated with the third uplink transmission component carrier, or a message indicating an uplink transmission component carrier from which the one or more transmit chains are to be switched.

In a twenty-fourth aspect, switching one or more transmit chains from a group of intra-band aggregated uplink transmission component carriers to the SRS component carrier is performed on a per-frequency band basis.

In a twenty-fifth aspect, the SRS component carrier comprises a component carrier that comprises uplink symbols and downlink symbols and is not associated with a physical control channel or a physical shared channel.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with techniques for SRS carrier switching and uplink transmission switching.

As shown in FIG. 10, in some aspects, process 1000 may include transmitting, to a UE, a request for capability information (block 1010). For example, the network node (e.g., using transmission component 1204 and/or communication manager 1206, depicted in FIG. 12) may transmit, to a UE, a request for capability information, as described above.

As further shown in FIG. 10, in some aspects, process 1000 may include receiving the capability information based at least in part on the request, wherein the capability information indicates an uplink transmission switching time (corresponding to a second capability switching time in the context) associated with switching a transmit chain from a first uplink transmission component carrier to a second uplink transmission component carrier and an SRS switching time (corresponding to a first capability switching time in the context) associated with switching a number of transmit chains from the second uplink transmission component carrier to an SRS component carrier associated with transmitting an SRS, wherein a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier (block 1020). For example, the network node (e.g., using reception component 1202 and/or communication manager 1206, depicted in FIG. 12) may receive the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, wherein a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier, as described above. In some aspects, a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

Process 1000 may include additional aspects, such as any single aspect or any combination of aspects described below and/or in connection with one or more other processes described elsewhere herein.

In a first aspect, the SRS switching time corresponds to a sum of a first amount of time and a second amount of time, wherein the first amount of time corresponds to an amount of time associated with switching a transmit chain from the second uplink transmission component carrier to the SRS component carrier and the second amount of time corresponds to an amount of time to switch a transmit chain from a first uplink transmission component carrier to the second uplink transmission component carrier.

In a second aspect, the SRS switching time corresponds to a sum of a first amount of time and a second amount of time, wherein the first amount of time corresponds to an amount of time associated with switching a transmit chain from the second uplink transmission component carrier to the SRS component carrier and the second amount of time corresponds to maximum of an amount of time to switch a transmit chain from the first uplink transmission component carrier to the second uplink transmission component carrier and an amount of time to switch a transmit chain from a third uplink transmission component carrier to the second uplink transmission component carrier.

In a third aspect, the SRS switching time corresponds to the sum of a first amount of time and the second amount of time based at least in part on the capability information not indicating the amount of time to switch the transmit chain from the first uplink transmission component carrier to the second uplink transmission component carrier and the amount of time to switch the transmit chain from the third uplink transmission component carrier to the second uplink transmission component carrier.

In a fourth aspect, the capability information further indicates the amount of time to switch the transmit chain from the third uplink transmission component carrier to the second uplink transmission component carrier.

In a fifth aspect, the amount of time to switch the transmit chain from the third uplink transmission component carrier to the second uplink transmission component carrier is different from the amount of time to switch the transmit chain from the first uplink transmission component carrier to the second uplink transmission component carrier.

In a sixth aspect, process 1000 includes receiving information indicating one or more uplink transmission component carriers in an uplink transmission component carrier switching group that are interrupted based at least in part on switching a transmit chain to the SRS component carrier.

In a seventh aspect, the information includes a separate indication for each of a plurality of uplink transmission component carriers included in the uplink transmission component carrier switching group.

In an eighth aspect, the information includes a first indication associated with a downlink communication channel and a second indication associated with an uplink communication channel.

In a ninth aspect, the capability information indicates that simultaneous transmissions across the SRS component carrier and the first uplink transmission component carrier are supported by the UE, and a number of transmit chains of the UE is insufficient to perform the simultaneous transmissions across the SRS component carrier and the first uplink transmission component carrier, and process 1000 includes receiving the SRS via the SRS component carrier or an uplink transmission via the first uplink transmission component carrier based at least in part on a priority associated with the SRS component carrier, a priority associated with the first uplink transmission component carrier, and a prioritization rule.

In a tenth aspect, the prioritization rule indicates that the priority associated with the first uplink transmission component carrier is a higher priority relative to the priority associated with the SRS component carrier based at least in part on a message to be transmitted via the first uplink transmission component carrier comprising a HARQ ACK.

In an eleventh aspect, the first uplink transmission component carrier is associated with a first frequency band and the second uplink transmission component carrier is associated with a second frequency band, and the capability information further indicates a maximum of the uplink transmission switching time associated with switching the transmit chain from the first uplink transmission component carrier to the second uplink transmission component and an uplink transmission switching time associated with switching a transmit chain from a third uplink transmission component carrier in a third frequency band to the second uplink transmission component carrier.

In a twelfth aspect, the first uplink transmission component carrier is associated with a first frequency band and the second uplink transmission component carrier is associated with a second frequency band, and the capability information further indicates a maximum of an amount of time associated with switching a transmit chain from the first uplink transmission component carrier to the SRS component carrier and an amount of time associated with switching a transmit chain from a third uplink transmission component carrier in a third frequency band to the SRS component carrier.

In a thirteenth aspect, switching one or more transmit chains from a group of intra-band aggregated uplink transmission component carriers to the SRS component carrier is performed on a per-frequency band basis.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier. The reception component 1102 may receive an indication to transmit an SRS in the SRS component carrier. The communication manager 1106 may perform a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

The transmission component 1104 may transmit the SRS based at least in part on switching, to the SRS component carrier, one or more transmit chains from the first uplink transmission component carrier and the second uplink transmission component carrier.

The communication manager 1106 may cause the one or more transmit chains to be switched from the SRS component carrier to a third uplink transmission component carrier based at least in part on transmitting the SRS.

The transmission component 1104 may transmit information indicating one or more uplink transmission component carriers in an uplink transmission component carrier switching group that are interrupted based at least in part on switching a transmit chain to the SRS component carrier.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 3-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a request for capability information. The reception component 1202 may receive the capability information based at least in part on the request, wherein the capability information indicates an uplink transmission switching time associated with switching a transmit chain from a first uplink transmission component carrier to a second uplink transmission component carrier and an SRS switching time associated with switching a number of transmit chains from the second uplink transmission component carrier to an SRS component carrier associated with transmitting an SRS, wherein a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

The reception component 1202 may receive information indicating one or more uplink transmission component carriers in an uplink transmission component carrier switching group that are interrupted based at least in part on switching a transmit chain to the SRS component carrier.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: transmitting capability information, wherein the capability information indicates a first capability switching time associated with switching a first number of transmit chains from a first uplink transmission component carrier to an SRS component carrier associated with transmitting an SRS and a second capability switching time associated with switching a transmit chain from a second uplink transmission component carrier to the first uplink transmission component carrier; receiving an indication to transmit an SRS in the SRS component carrier; and performing a transmission based on a determination of an SRS switching time associated with the SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

Aspect 2: The method of Aspect 1, wherein the SRS switching time corresponds to a sum of a first amount of time and a second amount of time, wherein the first amount of time corresponds to an amount of time associated with switching a transmit chain from the first uplink transmission component carrier to the SRS component carrier and the second amount of time corresponds to the second capability switching time.

Aspect 3: The method of Aspect 2, wherein the capability information indicates the first amount of time and the second amount of time.

Aspect 4: The method of any of Aspects 1-3, wherein the SRS switching time corresponds to a sum of a first amount of time and a second amount of time, wherein the first amount of time corresponds to an amount of time associated with switching a transmit chain from the first uplink transmission component carrier to the SRS component carrier and the second amount of time corresponds to maximum of an amount of time to switch a transmit chain from the second uplink transmission component carrier to the first uplink transmission component carrier and an amount of time to switch a transmit chain from a third uplink transmission component carrier to the first uplink transmission component carrier.

Aspect 5: The method of Aspect 4, wherein the capability information indicates the first amount of time and the second amount of time.

Aspect 6: The method of any of Aspects 1-5, wherein the SRS switching time corresponds to a sum of the first capability switching time and the second capability switching time based at least in part on the capability information not indicating a third capability switching time associated with switching a transmit chain from the second uplink transmission component carrier to the SRS component carrier.

Aspect 7: The method of any of Aspects 1-6, wherein the capability information further indicates a third capability switching time associated with switching a transmit chain from a third uplink transmission component carrier to the first uplink transmission component carrier.

Aspect 8: The method of Aspect 7, wherein the third capability switching time is different from the second capability switching time.

Aspect 9: The method of any of Aspects 1-8, wherein the capability information further indicates a third capability switching time associated with switching a transmit chain from the second uplink transmission component carrier to the SRS component carrier, and wherein the determination of the SRS switching time associated with the SRS transmission is further based at least in part on the third capability switching time.

Aspect 10: The method of Aspect 9, wherein the SRS switching time corresponds to a maximum of the first capability switching time and the third capability switching time.

Aspect 11: The method of any of Aspects 1-10, wherein the capability information further indicates a third capability switching time associated with switching, in parallel, a transmit chain from the first uplink transmission component carrier to the SRS component carrier and a transmit chain from the second uplink transmission component carrier to the SRS component carrier, and wherein the determination of the SRS switching time associated with the SRS transmission is further based at least in part on the third capability switching time.

Aspect 12: The method of any of Aspects 1-11, wherein an initial number of transmit chains associated with the first uplink transmission component carrier prior to transmitting the SRS and an initial number of transmit chains associated with the second uplink transmission component carrier prior to transmitting the SRS corresponds to a first uplink transmission switching state, the method further comprising: transmitting the SRS based at least in part on switching, to the SRS component carrier, one or more transmit chains from the first uplink transmission component carrier and the second uplink transmission component carrier; and causing the one or more transmit chains to switch from the SRS component carrier to the first uplink transmission component carrier and the second uplink transmission component carrier in accordance with the first uplink transmission switching state.

Aspect 13: The method of any of Aspects 1-12, wherein a first initial number of transmit chains associated with the first uplink transmission component carrier prior to transmitting the SRS and a second initial number of transmit chains associated with the second uplink transmission component carrier prior to transmitting the SRS corresponds to a first uplink transmission switching state, the method further comprising: transmitting the SRS based at least in part on switching, to the SRS component carrier, one or more transmit chains from the first uplink transmission component carrier and the second uplink transmission component carrier; and causing the one or more transmit chains to switch from the SRS component carrier to the second uplink transmission component carrier in accordance with a second uplink transmission switching state, wherein the second uplink transmission switching state corresponds to the first uplink transmission component carrier being associated with a first subsequent number of transmit chains and the second uplink transmission component carrier being associated with a second subsequent number of transmit chains, and wherein the first subsequent number of transmit chains is different from the first initial number of transmit chains, the second subsequent number of transmit chains is different from the second initial number of transmit chains, or a combination thereof.

Aspect 14: The method of Aspect 13, wherein one or more of the first uplink transmission switching state or the second uplink transmission switching state is configured by a network node.

Aspect 15: The method of any of Aspects 1-14, the method further comprising: transmitting the SRS based at least in part on switching, to the SRS component carrier, one or more transmit chains from the first uplink transmission component carrier and the second uplink transmission component carrier; and causing the one or more transmit chains to be switched from the SRS component carrier to a third uplink transmission component carrier based at least in part on transmitting the SRS.

Aspect 16: The method of any of Aspects 1-15, further comprising: transmitting information indicating one or more uplink transmission component carriers in an uplink transmission component carrier switching group that are interrupted based at least in part on switching a transmit chain to the SRS component carrier.

Aspect 17: The method of Aspect 16, wherein the information includes a separate indication for each of a plurality of uplink transmission component carriers included in the uplink transmission component carrier switching group.

Aspect 18: The method of Aspect 16, wherein the information includes a first indication associated with a downlink communication channel and a second indication associated with an uplink communication channel.

Aspect 19: The method of any of Aspects 1-18, wherein the capability information indicates that simultaneous transmissions across the SRS component carrier and the first uplink transmission component carrier are supported by the UE, and wherein a number of transmit chains of the UE is insufficient to perform the simultaneous transmissions across the SRS component carrier and the first uplink transmission component carrier, the method further comprising: transmitting the SRS via the SRS component carrier or an uplink transmission via the first uplink transmission component carrier based at least in part on a priority associated with the SRS component carrier, a priority associated with the first uplink transmission component carrier, and a prioritization rule.

Aspect 20: The method of Aspect 19, wherein the prioritization rule indicates that the priority associated with the first uplink transmission component carrier is a higher priority relative to the priority associated with the SRS component carrier based at least in part on a message to be transmitted via the first uplink transmission component carrier comprising a HARQ ACK.

Aspect 21: The method of any of Aspects 1-20, wherein the first uplink transmission component carrier is associated with a first frequency band and the second uplink transmission component carrier is associated with a second frequency band, and wherein the capability information further indicates a maximum of the uplink transmission switching time associated with switching the transmit chain from the first uplink transmission component carrier to the second uplink transmission component carrier and an uplink transmission switching time associated with switching a transmit chain from a third uplink transmission component carrier in a third frequency band to the second uplink transmission component carrier.

Aspect 22: The method of any of Aspects 1-21, wherein the first uplink transmission component carrier is associated with a first frequency band and the second uplink transmission component carrier is associated with a second frequency band, and wherein the determination of the SRS switching time is based at least in part on a maximum of the second capability switching time and a third capability switching time associated with switching a transmit chain from a third uplink transmission component carrier in a third frequency band to the second uplink transmission component carrier.

Aspect 23: The method of any of Aspects 1-22, wherein a number of transmit chains associated with the second uplink transmission component carrier is less than a number of transmit chains associated with transmitting the SRS via the SRS component carrier, the method further comprising: switching one or more transmit chains from the first uplink transmission component carrier or a third uplink transmission component carrier based at least in part on an amount of time associated with switching a transmit chain from the first uplink transmission component carrier to the SRS component carrier and an amount of time associated with switching a transmit chain from the third uplink transmission component carrier to the SRS component carrier.

Aspect 24: The method of any of Aspects 1-23, wherein a number of transmit chains associated with the second uplink transmission component carrier is less than a number of transmit chains associated with transmitting the SRS via the SRS component carrier, the method further comprising: switching one or more transmit chains from the first uplink transmission component carrier or a third uplink transmission component carrier based at least in part on one or more of: a priority associated with the first uplink transmission component carrier and a priority associated with the third uplink transmission component carrier, a cell index associated with the first uplink transmission component carrier and a cell index associated with the third uplink transmission component carrier, or a message indicating an uplink transmission component carrier from which the one or more transmit chains are to be switched.

Aspect 25: The method of any of Aspects 1-24, wherein switching one or more transmit chains from a group of intra-band aggregated uplink transmission component carriers to the SRS component carrier is performed on a per-frequency band basis.

Aspect 26: The method of any of Aspects 1-25, wherein the SRS component carrier comprises a component carrier that comprises uplink symbols and downlink symbols and is not associated with a physical control channel or a physical shared channel.

Aspect 27: A method of wireless communication performed by a network node, comprising: transmitting, to a UE, a request for capability information; and receiving the capability information based at least in part on the request, wherein the capability information indicates an uplink transmission switching time associated with switching a transmit chain from a first uplink transmission component carrier to a second uplink transmission component carrier and a sounding reference signal (SRS) switching time associated with switching a number of transmit chains from the second uplink transmission component carrier to an SRS component carrier associated with transmitting an SRS, wherein a determination of the SRS switching time is based at least in part on an uplink transmission switching state of the first uplink transmission component carrier, an uplink transmission switching state of the second uplink transmission component carrier, and the number of transmit chains to be switched from the one or more uplink transmission component carriers to the SRS component carrier.

Aspect 28: The method of Aspect 27, wherein the SRS switching time corresponds to a sum of a first amount of time and a second amount of time, wherein the first amount of time corresponds to an amount of time associated with switching a transmit chain from the second uplink transmission component carrier to the SRS component carrier and the second amount of time corresponds to an amount of time to switch a transmit chain from a first uplink transmission component carrier to the second uplink transmission component carrier.

Aspect 29: The method of any of Aspects 27-28, wherein the SRS switching time corresponds to a sum of a first amount of time and a second amount of time, wherein the first amount of time corresponds to an amount of time associated with switching a transmit chain from the second uplink transmission component carrier to the SRS component carrier and the second amount of time corresponds to maximum of an amount of time to switch a transmit chain from the first uplink transmission component carrier to the second uplink transmission component carrier and an amount of time to switch a transmit chain from a third uplink transmission component carrier to the second uplink transmission component carrier.

Aspect 30: The method of Aspect 29, wherein the SRS switching time corresponds to the sum of a first amount of time and the second amount of time based at least in part on the capability information not indicating the amount of time to switch the transmit chain from the first uplink transmission component carrier to the second uplink transmission component carrier and the amount of time to switch the transmit chain from the third uplink transmission component carrier to the second uplink transmission component carrier.

Aspect 31: The method of Aspect 29, wherein the capability information further indicates the amount of time to switch the transmit chain from the third uplink transmission component carrier to the second uplink transmission component carrier.

Aspect 32: The method of Aspect 31, wherein the amount of time to switch the transmit chain from the third uplink transmission component carrier to the second uplink transmission component carrier is different from the amount of time to switch the transmit chain from the first uplink transmission component carrier to the second uplink transmission component carrier.

Aspect 33: The method of any of Aspects 27-32, further comprising: receiving information indicating one or more uplink transmission component carriers in an uplink transmission component carrier switching group that are interrupted based at least in part on switching a transmit chain to the SRS component carrier.

Aspect 34: The method of Aspect 33, wherein the information includes a separate indication for each of a plurality of uplink transmission component carriers included in the uplink transmission component carrier switching group.

Aspect 35: The method of Aspect 33, wherein the information includes a first indication associated with a downlink communication channel and a second indication associated with an uplink communication channel.

Aspect 36: The method of any of Aspects 27-35, wherein the capability information indicates that simultaneous transmissions across the SRS component carrier and the first uplink transmission component carrier are supported by the UE, and wherein a number of transmit chains of the UE is insufficient to perform the simultaneous transmissions across the SRS component carrier and the first uplink transmission component carrier, the method further comprising: receiving the SRS via the SRS component carrier or an uplink transmission via the first uplink transmission component carrier based at least in part on a priority associated with the SRS component carrier, a priority associated with the first uplink transmission component carrier, and a prioritization rule.

Aspect 37: The method of Aspect 36, wherein the prioritization rule indicates that the priority associated with the first uplink transmission component carrier is a higher priority relative to the priority associated with the SRS component carrier based at least in part on a message to be transmitted via the first uplink transmission component carrier comprising a HARQ ACK.

Aspect 38: The method of any of Aspects 27-37, wherein the first uplink transmission component carrier is associated with a first frequency band and the second uplink transmission component carrier is associated with a second frequency band, and wherein the capability information further indicates a maximum of the uplink transmission switching time associated with switching the transmit chain from the first uplink transmission component carrier to the second uplink transmission component and an uplink transmission switching time associated with switching a transmit chain from a third uplink transmission component carrier in a third frequency band to the second uplink transmission component carrier.

Aspect 39: The method of any of Aspects 27-38, wherein the first uplink transmission component carrier is associated with a first frequency band and the second uplink transmission component carrier is associated with a second frequency band, and wherein the capability information further indicates a maximum of an amount of time associated with switching a transmit chain from the first uplink transmission component carrier to the SRS component carrier and an amount of time associated with switching a transmit chain from a third uplink transmission component carrier in a third frequency band to the SRS component carrier.

Aspect 40: The method of any of Aspects 27-39, wherein switching one or more transmit chains from a group of intra-band aggregated uplink transmission component carriers to the SRS component carrier is performed on a per-frequency band basis.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
transmitting capability information, wherein the capability information indicates a first capability switching time associated with switching a first number of transmit chains from a second uplink transmission component carrier to a sounding reference signal (SRS) component carrier associated with transmitting an SRS and a second capability switching time associated with switching a transmit chain from a first uplink transmission component carrier to the second uplink transmission component carrier, wherein the SRS component carrier comprises a component carrier that comprises uplink symbols and downlink symbols and is not associated with a physical control channel or a physical shared channel;
receiving an indication to transmit an SRS in the SRS component carrier; and
performing a transmission based on a determination of an SRS switching time associated with an SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

2. The method of claim 1, wherein the SRS switching time corresponds to a sum of a first amount of time and a second amount of time, wherein the first amount of time corresponds to an amount of time associated with switching a transmit chain from the second uplink transmission component carrier to the SRS component carrier and the second amount of time corresponds to the second capability switching time.

3. The method of claim 2, wherein the capability information indicates the first amount of time and the second amount of time.

4. The method of claim 1, wherein the SRS switching time corresponds to a sum of the first capability switching time and the second capability switching time based at least in part on the capability information not indicating a third capability switching time associated with switching a transmit chain from the first uplink transmission component carrier to the SRS component carrier.

5. The method of claim 1, wherein the capability information further indicates a third capability switching time associated with switching a transmit chain from the first uplink transmission component carrier to the SRS component carrier, and wherein the determination of the SRS switching time associated with the SRS transmission is further based at least in part on the third capability switching time.

6. The method of claim 5, wherein the SRS switching time corresponds to a largest amount of time between the first capability switching time and the third capability switching time.

7. The method of claim 1, the method further comprising:
transmitting the SRS based at least in part on switching, to the SRS component carrier, one or more transmit chains from the first uplink transmission component carrier and the second uplink transmission component carrier; and
causing the one or more transmit chains to be switched from the SRS component carrier to the second uplink transmission component carrier based at least in part on transmitting the SRS.

8. The method of claim 1, further comprising:
transmitting information indicating one or more uplink transmission component carriers in an uplink transmission component carrier switching group that are interrupted based at least in part on switching a transmit chain to the SRS component carrier.

9. The method of claim 8, wherein the information includes a separate indication for each of a plurality of uplink transmission component carriers included in the uplink transmission component carrier switching group.

10. The method of claim 1, wherein the capability information indicates that simultaneous transmissions across the SRS component carrier and the first uplink transmission component carrier are supported by the UE, and wherein a number of transmit chains of the UE is insufficient to perform the simultaneous transmissions across the SRS component carrier and the first uplink transmission component carrier, the method further comprising:
transmitting the SRS via the SRS component carrier or an uplink transmission via the first uplink transmission component carrier based at least in part on a priority associated with the SRS component carrier, a priority associated with the first uplink transmission component carrier, and a prioritization rule.

11. The method of claim 10, wherein the prioritization rule indicates that the priority associated with the first uplink transmission component carrier is a higher priority relative to the priority associated with the SRS component carrier based at least in part on a message to be transmitted via the first uplink transmission component carrier comprising a hybrid automatic repeat request (HARQ) acknowledgement (ACK), and indicates that the priority associated with the SRS transmission component carrier is a higher priority relative to the priority associated with the first uplink component carrier based at least in part on the first uplink transmission component carrier is scheduled to transmit a PUSCH communication with CQI/PMI only.

12. The method of claim 1, wherein the first uplink transmission component carrier is associated with a first frequency band and the second uplink transmission component carrier is associated with a second frequency band, wherein the capability information further indicates a largest amount of time between the uplink transmission switching time associated with switching the transmit chain from the first uplink transmission component carrier to the second uplink transmission component carrier and an uplink transmission switching time associated with switching a transmit chain from a third uplink transmission component carrier in a third frequency band to the second uplink transmission component carrier, and wherein the determination of the SRS switching time is based at least in part on a largest amount of time between the second capability switching time and the uplink switching time associated with switching the transmit chain from the third uplink transmission component carrier in the third frequency band to the second uplink transmission component carrier.

13. The method of claim 1, wherein a number of transmit chains associated with the second uplink transmission component carrier is less than a number of transmit chains associated with transmitting the SRS via the SRS component carrier, the method further comprising:
switching one or more transmit chains from the first uplink transmission component carrier or a third uplink transmission component carrier based at least in part on an amount of time associated with switching a transmit chain from the first uplink transmission component carrier to the SRS component carrier and an amount of time associated with switching a transmit chain from the third uplink transmission component carrier to the SRS component carrier.

14. The method of claim 1, wherein the first uplink transmission component carrier and the second uplink component carrier comprise a group of intra-band aggregated uplink transmission component carriers associated with a fourth number of transmit chains, and wherein switching one or more transmit chains from the fourth number of transmit chains to the SRS component carrier is performed on a per-frequency band basis.

15. A user equipment (UE) for wireless communication, comprising:
one or more memories; and
one or more processors, coupled to the one or more memories, configured to cause the UE to:
transmit capability information, wherein the capability information indicates a first capability switching time associated with switching a first number of transmit chains from a second uplink transmission component carrier to a sounding reference signal (SRS) component carrier associated with transmitting an SRS and a second capability switching time associated with switching a transmit chain from a first uplink transmission component carrier to the second uplink transmission component carrier, wherein the SRS component carrier comprises a component carrier that comprises uplink symbols and downlink symbols and is not associated with a physical control channel or a physical shared channel;
receive an indication to transmit an SRS in the SRS component carrier; and
perform a transmission based on a determination of an SRS switching time associated with an SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.

16. The UE of claim 15, wherein the SRS switching time corresponds to a sum of a first amount of time and a second amount of time, wherein the first amount of time corresponds to an amount of time associated with switching a transmit chain from the second uplink transmission component carrier to the SRS component carrier and the second amount of time corresponds to the second capability switching time.

17. The UE of claim 16, wherein the capability information indicates the first amount of time and the second amount of time.

18. The UE of claim 15, wherein the capability information further indicates a third capability switching time associated with switching a transmit chain from the first uplink transmission component carrier to the SRS component carrier, and wherein the determination of the SRS switching time associated with the SRS transmission is further based at least in part on the third capability switching time.

19. The UE of claim 18, wherein the SRS switching time corresponds to a largest amount of time between the first capability switching time and the third capability switching time.

20. A method of wireless communication performed by a network node, comprising:
transmitting a request for capability information;
receiving the capability information based at least in part on the request, wherein the capability information indicates a first capability switching time associated with switching a first number of transmit chains from a second uplink transmission component carrier to a sounding reference signal (SRS) component carrier associated with transmitting an SRS and a second capability switching time associated with switching a transmit chain from a first uplink transmission component carrier to the second uplink transmission component carrier, wherein the SRS component carrier comprises a component carrier that comprises uplink symbols and downlink symbols and is not associated with a physical control channel or a physical shared channel;
transmitting an indication to transmit an SRS in the SRS component carrier based on a determination of an SRS switching time associated with an SRS transmission, wherein the SRS switching time is associated with switching a second number of transmit chains to the SRS component carrier, and wherein the determination of the SRS switching time is based at least in part in on one or more of a third number of transmit chains associated with the first uplink transmission component carrier, a fourth number of transmit chains associated with the second uplink transmission component carrier, and the second number of transmit chains to be switched to the SRS component carrier.
